(19) United States
(12) Patent Application Publication
(10) Pub. No.: US 2016/0070055 A1
(43) Pub. Date: Mar. 10, 2016

(54) LIGHT BAR COMPONENT, BACKLIGHT MODULE AND LCD DEVICE

(71) Applicant: Shenzhen China Star Optoelectronics Technology Co. Ltd., Shenzhen, Guangdong (CN)

(72) Inventor: Hu He, Shenzhen (CN)

(73) Assignee: Shenzhen China Star Optoelectronics Technology Co. Ltd., Shenzhen, Guangdong (CN)

(21) Appl. No.: 14/396,051

(22) PCT Filed: Sep. 16, 2014
(86) PCT No.: PCT/CN2014/086632

§ 371 Date: Oct. 21, 2014

(30) Foreign Application Priority Data
Sep. 9, 2014 (CN) 201410456333.5

(51) Int. Cl. F21V 8/00

(52) U.S. Cl. CPC G02B 6/0073; G02B 6/0068; G02B 6/0083

(57) ABSTRACT

A light bar component is disclosed. The light bar component comprises two or more than two light bars. Each of the light bars comprises a light source print circuit board and a plurality of light sources assembled on the light source print circuit board; a flexible print circuit board comprising a main body portion of the flexible print circuit board and a lead-out portion of a gold finger, wherein the main body portion of the flexible print circuit board connects with the light source print circuit board of all of the light bars. The lead-out portion of the golden finger connects with the power source which provides the driving voltage for the flexible print circuit board. The light bar component and the backlight module using the light bar component can reduce the use amount of the wire harness. Moreover, the flexible print circuit board directly combines with the light source print circuit board by the hot pressing technology. The electric connector is not used anymore. The present invention reduces the technical difficulty of the product assembly, enhances the product yield and saves the assembly time and the cost.

### FIELD OF THE INVENTION

The present invention relates to the technical field of the liquid crystal display; especially, to a light bar component and also a backlight module having the light bar component and an LCD device comprising the backlight module.

### BACKGROUND OF THE INVENTION

The LCD device usually has a liquid crystal panel and a backlight module which is disposed in opposite to the liquid crystal panel. The backlight module provides light source for the liquid crystal panel to show the image on the panel.

Because the LED light source has many outstanding characteristics, for example, low power consumption, long life time and color reproduction characteristic and contrast. In the LCD display nowadays, the backlight source in the backlight module uses LEDs. As shown in FIG. 1, in the light bar component of the backlight module of the traditional technology, many LED lamps 3 are used as light sources and assembled on the light source print circuit board 2 to form a light bar 1. An electrical connector 4 is assembled on the light source print circuit board 2. The LED lamps 3 and the electrical connector 4 are located in the same side of the light source print circuit board 2. The electrical connector 4 connects with the power source 5 via the flexible flat cable 6 (FFC). The power source 5 provides the driving voltage for the LED lamps 3 in the light bar 1 via the flexible flat cable 6 and the electrical connector 4.

In some backlight modules, a pair of the light bars is required, and each light bar 1 and electric power 5 respectively connects with the different flexible flat cable 6 by the means of plugging. When the coil generates skew, the socket is easy to be damaged. Moreover, while a large number of the flexible flat cables are used, the much space is occupied. It results in the inconvenience of the assembly and affects the time and yield of the product assembly. Otherwise, the above structure of the light bar components, the height of the electric connectors 4 is usually higher than the height of the LED lamp 3. Therefore, it needs more space to assemble the light bar. It is not conducive to achieve the narrow bezel design of the LCD device.

### SUMMARY OF THE INVENTION

In order to solve the above mentioned issues exiting in the traditional art, the present invention provides a light bar component, the light bar component is used in the backlight module. The present invention can reduce the technical difficulty of the product assembly, improve the produce yield and save the assemble time and the cost.

In order to achieve the goal mentioned before, the present invention adopts the following technical solution:

A light bar component which comprises:

two or more than two light bars, each of the light bars comprises a light source print circuit board and a plurality of light sources assembled on the light source print circuit board; and

a flexible print circuit board, comprising a main body portion of the flexible print circuit board and a lead-out portion of a golden finger, wherein the main body portion of the flexible print circuit board connects with the light source print circuit board of all of the light bars, the lead-out portion of the golden finger connects with a power source, the power source provides the driving voltage for the light bars through the flexible print circuit board.

Further, the light bar component comprises two light bars, the main body portion of the flexible print circuit board is a long strip structure and each of two ends of the main body portion connects to the light source print circuit board one of the light bars, the lead-out portion of the golden finger extracts from middle portion of the main body portion of the flexible print circuit board.

Further, the main portion of the flexible print circuit board further connects with a plurality of the light sources which form a light bar structure on the main portion of the flexible print circuit board.

Further, the light source connects with the main portion of the flexible print circuit board by surface mounting technology.

Further, the main portion of the flexible print circuit board connects with the light source print circuit board by the hot pressing technology.

Further, the light source is LED.

On the other hand, the present invention provides a backlight module comprising a backlight source and a guide plate, and the backlight source is located in a side face of the light guide plate, wherein the backlight source comprises the light bar component.

The present invention further provides a LCD device, comprising a liquid crystal panel and a backlight module, and the liquid crystal panel is set in opposite to the backlight module. The backlight module provides the light for the liquid crystal panel to show the images on the liquid crystal panel, wherein the backlight module is the above mentioned backlight module.

In the light bar component of the embodiment of the present invention and the backlight module adopts the light bar component, many light bars can use the connection of the flexible print circuit board and the electric power. The electric power provides the driving voltage for the light bar via the flexible print circuit board. It can reduce the use amount of the wiring harness. Moreover, the electric connector is not used in the light bar component. The flexible print circuit combines with the light source print circuit board via the hot pressing technology. The present invention lowers the difficulty of the product assembly, enhances the product yield, and saves assembly time and the cost. Otherwise, because of the decrease of the harness use amount and non-use of the electric connector, the light bar component occupies less assembly space to achieve the narrow bezel design of the LCD device.

### BRIEF DESCRIPTION OF THE DRAWINGS

FIG. 1 is the schematic diagram of the light bar component in the traditional backlight module.

FIG. 2 is the schematic diagram of the backlight module and the LCD device of the present invention.

FIG. 3 is the schematic diagram of the light bar component of one embodiment of the present invention.

FIG. 4 is the schematic diagram of the light bar component of the other embodiment of the present invention.

### DETAILED DESCRIPTION OF THE PREFERRED EMBODIMENTS

As the traditional technology mentioned above, the present invention provides a light bar component, and the light bar component comprises two and more than tow light bars and the flexible print circuit board. Each of the light bars comprises a light source print circuit board and a plurality of light sources assembled on the light source print circuit board. The flexible print circuit board comprises a main body portion of the flexible print circuit board and a lead-out portion of a golden finger, and the main body portion of the flexible print circuit board connects with the light source print circuit board of all of the light bars. The lead-out portion of the golden finger connects with the power source. The light source offers the driving voltage to the light bars via the flexible print circuit board.

As above mentioned light bar component which is used in the backlight module, the electric power source provides the driving voltage to the light bar via the flexible print circuit board because a plurality of the light bars can use the same flexible print circuit board to connect to the power source. Moreover, the electric connector is not used again in the light bar component. The flexible print circuit board directly connects with the light source print circuit board by the hot pressing process, such that the technical difficulty of the produce assembly is lowered, the product yield is improved, and the assembly time and the cost are saved.

In order to elaborate the technical characteristics and the structure of the present invention well, the following examples combining with the accompanying drawings in detail.

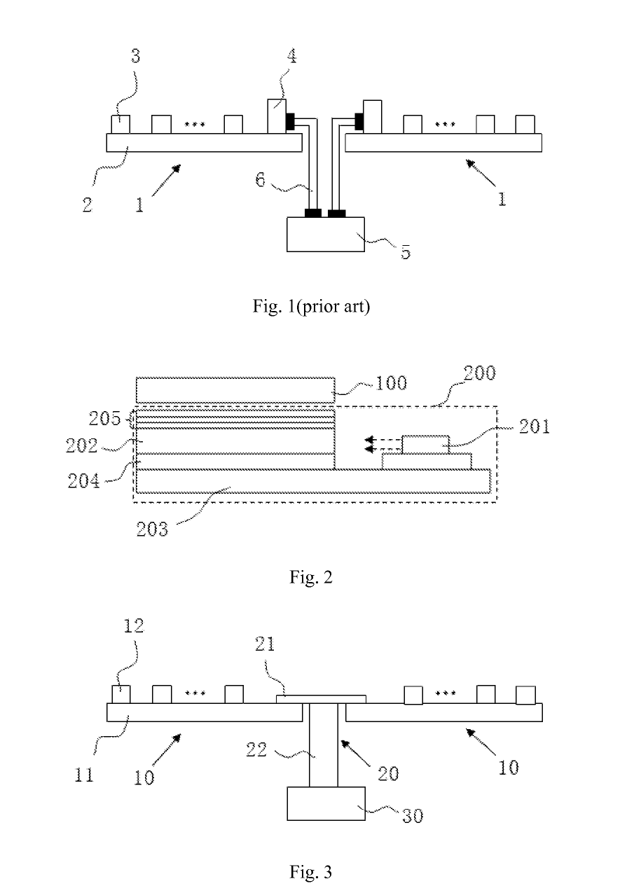

FIG. 2 is the schematic diagram of the backlight module and the LCD device that the present invention provided. As shown in FIG. 2, the LCD device comprises a liquid crystal panel 100 and the backlight module 200, and the liquid crystal panel 100 are disposed in opposite to the backlight module 200. The backlight module 200 provides light for the liquid crystal panel 100 to make the liquid crystal panel show the image. The backlight module 200 comprises a back plate 203, a reflection plate 204, a light guide plate 202 and an optical film set 205 arranged in a laminated manner, and further comprises a backlight module located in a side face of the backlight source 201. The light from the backlight source 201 emits through the light guide plate 202, then the optical film set 205, and finally into the liquid crystal panel 100.

The backlight source 201 comprises the light bar component. Specifically, in the embodiment, as shown in FIG. 3, the light bar component comprises two light bars 10 (more than two light bars can be disposed in the other embodiment) and the flexible print circuit board 20. Each of the light bars 10 comprises the light source print circuit board 11 and a plurality of light sources 12 assembled on the light source print circuit board 11. In the embodiment, the light source 12 is LED. The flexible print circuit board 20 comprises the main body portion 21 of the flexible print circuit and the lead-out portion 22 of the golden finger. The flexible print circuit board is a long strip structure of which each of the ends respectively connects with the light source print circuit board of one of the light bars The lead-out portion 22 of the golden finger extracts from the middle portion of the main body portion 21 of the flexible print circuit board and then connects with the power source 30. The power source 30 offers the driving voltage to the light bars 10 via the flexible print circuit board 20.

The main body portion 21 of the flexible print circuit board connects with the light source print circuit board 11 by the hot pressing technology without disposing any electric connector on the light source print circuit board 11.

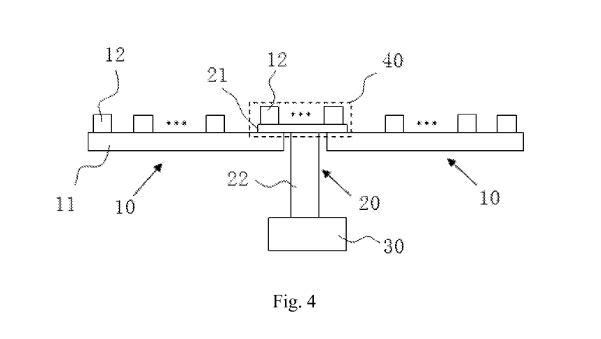

In the other preferred embodiment, as shown in FIG. 4, it is similar with the embodiment mentioned above. The light bar component comprises two light bars 10 and a flexible print circuit board 20. Each of the light bars 10 comprises a light source print circuit board 11 and a plurality of light sources 12 assembled on the light source print circuit board. In the other embodiment, the light source 12 is LED. The flexible print circuit board 20 comprises the main body portion 21 of the flexible print circuit board and the lead-out portion 22 of the gold finger. In the other embodiment, the main body portion of the flexible print circuit board 21 is a long strip structure of which two ends respectively connects with the light source print circuit board 11 of each of the light bars 10. The lead-out portion of the golden finger 22 extracts from the middle position of the main body portion 21 of the flexible print circuit board and then connects to the power source 30. Further, a plurality of light sources 12 connect with the main body portion 21 of the flexible print circuit board by the surface mounting technology to form a light bar structure 40 on the main body portion 21 of the flexible print circuit board. The more light sources 12 can be assembled in the smaller space. The power source 30 provides the driving voltage to the light bar 10 and the light bar structure 40 via the flexible print circuit board 20.

In summary, in the light bar component of the present invention and the backlight module having the light bar component, a plurality of the light bars can use only one flexible print circuit board to connect with the power source. The power source provides the driving voltage to the light bar through the flexible print circuit with reducing the use amount of wire harness; furthermore, the electric connector is not used anymore in the light bar component. The flexible print circuit board combines with the light source print circuit board by the hot pressing technology and it can reduce the technical difficulty of the product assembly, enhance the product yield and save the assembly time and the cost. Otherwise, because of the reduction of the amount use of the wire harness and non-use of the electric connector, the light bar component has less assembly space such that it is conducive for the narrow bezel design of the liquid crystal display.

It should be noted that, herein, relational terms such as first and second, and the like are only used to distinguish one entity or operation from another entity or action separate, and does not necessarily imply that these entities or the existence of any such relationship or order between actual or operation. Moreover, the terms “comprises,” “comprising,” or any other variation thereof, are intended to cover a non-exclusive inclusion, such that a series of elements including the process, method, article or device that includes only those elements not expressly listed and further comprising other elements, or further include such process, method, article or device inherent elements. Without more constraints, by the statement “includes one . . . ” element defined does not exclude the existence of additional identical elements in the process, including the element, method, article, or apparatus.

Clearly, the scope of the present invention is not limited to the specific embodiments of appeal, the person skilled in the art of the present invention can be various modifications and variations are possible without departing from the spirit and scope of the invention. Thus, if these modifications and variations of the present invention and the claims of the invention are within the scope of technical equivalents, the present invention is also intended to include these changes and modifications included.

What is claimed is:

1. A light bar component characterized by comprising:
two or more than two light bars, each of the light bars comprises a light source print circuit board and a plurality of light sources assembled on the light source print circuit board; and
a flexible print circuit board, comprising a main body portion of the flexible print circuit board and a lead-out portion of a golden finger, wherein the main body portion of the flexible print circuit board connects with the light source print circuit board of all of the light bars, the lead-out portion of the golden finger connects with a power source, the power source provides driving voltage for the light bars through the flexible print circuit board.

2. The light bar component as claimed in claim 1, wherein the light bar component comprises two light bars, the main body portion of the flexible print circuit board is a long strip structure and each of two ends of the main body portion connects to the light source print circuit board one of the light bars, the lead-out portion of the golden finger extracts from middle portion of the main body portion of the flexible print circuit board.

3. The light bar component as claimed in claim 2, wherein the main portion of the flexible print circuit board further connects with a plurality of the light sources which form a light bar structure on the main portion of the flexible print circuit board.

4. The light bar component as claimed in claim 3, wherein the light source connects with the main portion of the flexible print circuit board by surface mounting technology.

5. The light bar component as claimed in claim 1, wherein the main portion of the flexible print circuit board connects with the light source print circuit board by hot pressing technology.

6. The light bar component as claimed in claim 1, wherein the light source is LED.

7. A backlight module, comprising a back light source and a light guide plate, the backlight source located on a side face of the light guide plate, wherein the backlight source comprises a light bar component, and the light bar component comprises:
more than two light bars, each of the light bars comprises a light source print circuit board and a plurality of light sources assembled on the light source print circuit board; and
a flexible print circuit board, comprising a main body portion of the flexible print circuit board and a lead-out portion of a golden finger, wherein the main body portion of the flexible print circuit board connects with the light source print circuit board of all the light bars, the lead-out portion of the golden finger connects with a electric power, the electric power provides driving voltage for the light bars through the flexible print circuit board.

8. The backlight module as claimed in claim 7, wherein the light bar component comprises two light bars, the main body portion of the flexible print circuit board is a long strip structure and each of two ends of the main body portion connects to the light source print circuit board one of the light bars, the lead-out portion of the golden finger extracts from middle portion of the main body portion of the flexible print circuit board.

9. The backlight module as claimed in claim 8, wherein the main portion of the flexible print circuit board further connects with a plurality of the light sources which form a light bar structure on the main portion of the flexible print circuit board.

10. The backlight module as claimed in claim 9, wherein the light source connects with the main portion of the flexible print circuit board by surface mounting technology.

11. The backlight module as claimed in claim 7, wherein the main portion of the flexible print circuit board connects with the light source print circuit board by hot pressing technology.

12. The light bar component as claimed in claim 7, wherein the light source is LED.

13. A LCD device, comprising a liquid crystal panel and a backlight module, and the liquid crystal panel is disposed in opposite to the backlight module, the backlight module provides light for the liquid crystal panel to show images on the liquid crystal panel, wherein the backlight module comprises a backlight source and a light guide plate, and the light guide plate is positioned in a side face of the light guide plate, and the backlight module comprises a light bar component, and the light bar component comprises:
more than two light bars, each of the light bars comprises a light source print circuit board and a plurality of light sources assembled on the light source print circuit board; and
a flexible print circuit board, comprising a main body portion of the flexible print circuit board and a lead-out portion of a golden finger, wherein the main body portion of the flexible print circuit board connects with the light source print circuit board of all the light bars, the lead-out portion of the golden finger connects with a power, the power provides driving voltage for the light bars through the flexible print circuit board.

14. The LCD device as claimed in claim 13, wherein the light bar component comprises two light bars, the main body portion of the flexible print circuit board is a long strip structure and each of two ends of the main body portion connects to the light source print circuit board one of the light bars, the lead-out portion of the golden finger extracts from middle portion of the main body portion of the flexible print circuit board.

15. The LCD device as claimed in claim 14, wherein the main portion of the flexible print circuit board further connects with a plurality of the light sources which form a light bar structure on the main portion of the flexible print circuit board.

16. The LCD device as claimed in claim 15, wherein the light source connects with the main portion of the flexible print circuit board by surface mounting technology.

17. The LCD device as claimed in claim 13, wherein the main portion of the flexible print circuit board connects with the light source print circuit board by hot pressing process.

18. The LCD device as claimed in claim 13, wherein the light source is LED.
